(19) United States
(12) Patent Application Publication
(10) Pub. No.: US 2024/0058196 A1
(43) Pub. Date: Feb. 22, 2024

(54) FOOT SUPPORT SYSTEM FOR A FOOT MODULE OF A REHABILITATION MECHANISM

(71) Applicant: ReActive Robotics GmbH, München (DE)

(72) Inventors: Manfred KÖSTLMEIER, Haar (DE); Ramona Susanna SCHLÄFER, München (DE); Maximilian GROSSE-DUNKER, Puchheim (DE); Antonin Lucas DORÉ, München (DE); Michael ZIEGLER, Unterhaching (DE); Alexander KÖNIG, München (DE); Helfried PEYRL, Oberhaching (DE)

(21) Appl. No.: 18/261,039

(22) PCT Filed: Jan. 14, 2022
(86) PCT No.: PCT/DE2022/100034

§ 371 Date: Jul. 11, 2023

(30) Foreign Application Priority Data
Jan. 15, 2021 (DE) 10 2021 100 829.8

(51) Int. Cl. A61H 1/02

(52) U.S. Cl. CPC A61H 1/0262; A61H 2201/0192; A61H 2201/1642

(57) ABSTRACT

Disclosed is a foot support system for a foot module of a rehabilitation mechanism, the foot support system having an inner shell for receiving a person's foot, an outer shell for connection to a foot module of a rehabilitation mechanism, and at least one strap for fixing the foot to the foot support system. The inner shell, preferably on its side opposite a receiving region for the foot, has at least one connection for reversibly connecting the inner and outer shells, and wherein the outer shell, preferably at least on its side facing the inner shell when the inner shell and outer shell are connected, has at least one receiver corresponding to the at least one connection of the inner shell. By virtue of its modular set up, it permits simple, quick and comfortable connection to a foot module and advantageously protects and stabilizes the foot in particular during movement.

### FIELD OF THE INVENTION

The present invention relates to a foot support system for a foot module of a rehabilitation mechanism.

### BACKGROUND OF THE INVENTION

During long phases of confinement to bed, physiotherapy exercises, which the patient in most cases performs with the assistance of a person specially trained in physiotherapy, can maintain the mobility and muscle mass of the patient, promote the circulation of blood through the body and thus reduce the risk of clotting, for example.

In the case of bedridden patients who are unconscious, kinesitherapy of the lower extremities has in particular proven effective since, by movement of the legs, large muscle groups of the body can be trained and thus a greater stimulus can be triggered for the patient's brain. Physiotherapy exercises can thus even accelerate healing of damaged regions of the brain and can facilitate waking from a coma.

So that said medically valuable, but time- and labor-intensive kinesitherapy, in particular in the form of what is referred to as gait therapy, can be of benefit as frequently as possible to as many patients as possible, attempts have been made in recent years to increasingly automate the kinesitherapy of bedridden patients, which is traditionally carried out manually by physiotherapists.

For example, the document WO 00/61059 A1 and also the document WO 2017/063639 A1 from the applicant disclose various rehabilitation mechanisms with which physiotherapy exercises, in particular gait therapy, can be carried out in an automated manner. As can be gathered from said documents, it has proven highly beneficial for the success of the therapy, when carrying out such gait therapies, if a certain part of the patient's weight acts on the patient, especially on their lower extremities, during movement. For severely impaired patients, in particular patients who are unconscious, the prior art makes provision for this purpose for the patient's lying surface to be verticalized. For the automated performance of the gait movement, on the one hand, but also for support and stabilization, on the other hand, the patient is then contacted at various points by the respective rehabilitation mechanism, with the focus generally being on the knee region or upper leg region and on the foot region. In contrast to the knee region and upper leg region, for which various contacting variants in the form of what are referred to as knee orthoses have already been developed, as known for example from WO 2020/103986 A1, the contact between foot and foot module has hitherto frequently been realized merely by directly strapping the feet onto the foot plate or the foot plates of a foot module.

Various possibilities for connecting a user's feet to a piece of sports equipment are already known from the sports and fitness sector. For example, US 2016/0 366 985 A1 and U.S. Pat. No. 7,503,579 B2 describe devices of this type for winter sports, in particular for connection of a sportsperson to a snowshoe or a snowboard. By contrast, US 2019/0 308 056 A1 discloses a device for the fitness sector, which permits the connection of conventional dumbbells to a sportsperson's feet. Finally, EP 2 949 234 A1 and DE 10 2012 106 428 A1 have disclosed devices which pertain more to the rehabilitation sector. In particular, DE 10 2012 106 428 A1 discloses a device for the therapeutic treatment of a person's lower extremities, in which a flexion means for the knee joint and various holding means for the upper leg and lower leg are connected to a frame which can be connected in the form of an exoskeleton to a person's lower extremities. The frame itself is then connectable in turn to a system for equipment-assisted locomotion therapy, wherein said connection is undertaken by a fastening means, in particular in the form of a horizontal metal plate at the end of the frame close to the ground, onto which metal plate the user's foot can also be placed. To hold the foot on said fastening means, a further holding means in the form of a sandal is described which is fixedly connected to the base plate or to the fastening means of the device by means of screws and/or rivets.

However, such a “simple” or conventional contact does not meet the need of the, frequently unconscious, patients who need particular stabilization and/or securing because of their impairments, especially in the foot region, on which a major portion of the weight force arises during gait therapy because of the verticalization.

### BRIEF SUMMARY OF THE INVENTION

Taking this as the starting point, the present invention is based on the object of enabling contact, which is improved in comparison to the prior art, between a rehabilitation mechanism, in particular the foot module thereof, and a patient's feet. The invention is intended to provide a rapid and simple possibility of connecting a patient's feet to said foot module, of securing the feet here against slipping out or away, of providing stabilization during a movement and at the same time providing the patient with a comfortable use sensation, in particular even if the patient is not wearing shoes. In order to make the work of the persons entrusted with the care and medical support of the patients as simple as possible in this respect, the necessity of using additional tools is intended to be avoided here.

This object is achieved by a foot support system having the features of independent patent claim 1.

A foot support system according to the invention for a foot module of a rehabilitation mechanism comprises at least
an inner shell for receiving a person's foot,
an outer shell for connection to a foot module of a rehabilitation mechanism; and
at least one strap for fixing the foot to the foot support system;
   wherein the inner shell comprises at least one connecting means for reversibly connecting the inner shell to the outer shell; and
   wherein the outer shell comprises at least one receiving means which is designed corresponding to the at least one connecting means of the inner shell.

Within the scope of this invention, a “reversible connection” in general and in particular a “reversible connection of the inner shell to the outer shell” is understood as meaning a controlled temporary fixing of various components (e.g. the temporary fixing of the inner shell to the outer shell) to one another and a likewise controlled removal of said components from one another, wherein no other aids whatsoever have to be used for the fixing and for the removal, in particular no tool, e.g. a screwdriver. Accordingly, a “reversible connection” within the scope of the present invention is distinguished inter alia in that it can be closed and released again within fractions of a second.

The foot support system according to the invention advantageously makes it possible for a person's foot, in particular if the person is not wearing shoes, to be connected to a foot module of a rehabilitation mechanism quickly and securely and nevertheless comfortably for the person's foot. To connect both feet of a person, in particular a patient, in order to prepare for kinesitherapy or gait therapy of the lower extremities, which is carried out by means of the rehabilitation mechanism, two of the foot support systems according to the invention accordingly have to be provided on the foot module of said rehabilitation mechanism. The inner shell of the foot support system according to the invention is simply insertable into the outer shell or removable again and, as a result, can advantageously be simply removed for cleaning purposes after use, whereas the outer shell can remain on the foot module. In particular, the interaction of inner shell, outer shell and strap advantageously ensures stabilization during the entire movement sequence of the movement guided (performed) by a rehabilitation mechanism and securing of the patient's foot against slipping out or slipping off the foot module.

Further advantageous embodiments and developments which are usable individually or in combination with one another are the subject matter of the respective dependent claims.

In a preferred embodiment of the invention, it has proven expedient if the at least one connecting means for reversibly connecting the inner shell to the outer shell is arranged on a side of the inner shell opposite a receiving region for the foot and/or in the region of at least one longitudinal side and/or transverse side of the inner shell; and if the at least one receiving means, which is designed corresponding to the connecting means, is arranged at least on a side of the outer shell facing the inner shell when the inner shell and outer shell are connected. Such an embodiment of the foot support system advantageously permits a particularly simple connection of inner shell and outer shell, particularly by simply placing the connecting means onto, and/or sliding same into, the receiving means.

In a further embodiment, it has proven expedient if the at least one connecting means is configured as a magnet, and if the at least one receiving means is configured as a magnetic region of a side of the outer shell facing the inner shell when the inner shell and outer shell are connected. A connecting means configured as a magnet advantageously permits the quick and simple reversible connection of inner shell and outer shell by formation of magnetic attraction forces between said connecting means and the receiving means, which is configured as a magnetic region, of the outer shell.

Alternatively thereto, in one embodiment of the invention, the receiving means can be designed as a guide track with an insertion opening for the connecting means, the guide track being able to run in particular parallel to the longitudinal axis of the outer shell. A receiving means configured as a guide track with an insertion opening advantageously prevents a right/left movement of the connecting means and therefore also of the inner shell in relation to the outer shell. Alternatively or cumulatively, the receiving means can also be designed as a latching mechanism, in particular as a spring latching mechanism, into which the connecting means is latched. A latching mechanism of this type, in which the connecting means, for example, can be pressed simply into the receiving means, advantageously prevents the unintentional release of inner shell and outer shell. By actuation of a button, the latching mechanism can then be unlocked after the end of a therapy session and the inner shell simply removed.

It has proven expedient here if the at least one connecting means is preferably designed as a mushroom-shaped component with a cap region, the diameter of which is designed corresponding to the diameter of the insertion opening of the receiving means, and a stalk region, the diameter of which is smaller than that of the cap region and is designed corresponding to the width of the guide track of the receiving means. A connecting means configured in such a way can advantageously be inserted into the receiving means, in particular via an insertion opening, and then moved within the receiving means, in particular along the guide track thereof. The larger diameter of the cap region in comparison to the diameter of the stalk region advantageously prevents the inner shell from slipping out or being pulled out of the outer shell upward, i.e. perpendicularly to the main plane of the outer shell or inner shell.

Moreover, it has proven expedient if the inner shell comprises two, three or preferably four connecting means, and the outer shell correspondingly comprises two, three or preferably four receiving means. If the inner shell and outer shell comprise more than in each case one connecting means or receiving means, in particular in each case two, three or preferably four, the stability of the connection between inner shell and outer shell is advantageously increased and rotation of the inner shell in relation to the outer shell with respect to an axis perpendicular to the main plane of the inner shell or outer shell is advantageously prevented.

In a further preferred embodiment of the invention, the outer shell can comprise at least one fixing receptacle which is designed corresponding to a fixing means of the inner shell and which is configured to prevent a movement of the connecting means within the receiving means, in particular along a guide track of the receiving means toward the insertion opening, when the fixing means is operatively connected to the fixing receptacle.

Moreover, it is of advantage if the inner shell comprises a rear wall which, preferably parabolically, closes the receiving region of the inner shell in the direction of a backwall of the outer shell. The rear wall here preferably has, at least in sections, a height of 8 to 10 cm, particularly preferably of 9 cm. A rear wall, which is preferably parabolic, with the opening of the parabola pointing away from the back wall of the outer shell, and which closes the receiving region of the inner shell in the direction of a back wall of the outer shell, advantageously permits the heel region of the foot to be supported and therefore increases the stability of the heel and of the ankle during movement. A wall height of 8 to 10 cm, particularly preferably of 9 cm, advantageously ensures sufficient stabilization of the foot in the heel region.

In a further embodiment of the invention, the inner shell can also comprise a fixing means which is configured as an opening designed corresponding to a back wall of the outer shell, the inner shell preferably comprising a rear wall which closes the receiving region of the inner shell in the direction of the back wall of the outer shell, and the fixing means configured as an opening preferably being arranged in the region between said rear wall and a rear end of the inner shell. A fixing means configured in such a way advantageously makes it possible for the back wall to pass through the fixing means, which is configured as an opening, when the inner shell and outer shell are connected and thus to prevent the inner shell and outer shell being displaced in relation to each other. This in turn advantageously prevents a movement of the connecting means within the receiving means, in particular along a guide track of the receiving means toward the insertion opening.

In addition, it has proven expedient if the inner shell is manufactured from plastic, and/or if the inner shell, in particular the receiving region and/or the rear wall of the inner shell, is provided with a padding layer. The use of plastic to manufacture the inner shell advantageously reduces the weight of the foot support system. Within the scope of robot-assisted kinesitherapy or gait therapy, in which the rehabilitation mechanism does not completely take on the movement, but rather intervenes only for assistance, a weight of the foot support system which is overall as low as possible makes it easier for the patient to raise the foot, which is fixed in the receiving region of the foot support system, together with the foot support system, for example, during the foot lifting phase. If, moreover, a plastic which can be disinfected is also used, this facilitates the hygienic cleaning of the inner shell after use. If the inner shell, in particular the receiving region and/or the rear wall of the inner shell, is provided with a padding layer, for example in the form of a mesh fabric, this firstly advantageously reduces the risk of an in particular bare foot slipping off/slipping out of the inner shell and secondly advantageously damps the pressure loading on the foot.

In a further preferred embodiment, the outer shell can be formed from a metallic material. An outer shell manufactured from a metallic material advantageously increases the stability of the foot support system and in particular provides a stable fastening point for the strap or the straps according to the invention.

Moreover, an embodiment of the invention has proven expedient, in which the at least one strap is arranged in the region of the rear wall of the inner shell within the foot support system and is configured to exert a tensile force on the ankle of a foot located in the receiving region, said tensile force acting both in the direction of the main plane of the inner shell and in the direction of the rear wall. This can be brought about, for example, by the at least one strap running obliquely with respect to the main plane of the inner shell and, when stretching over the receiving region, contacting the foot approximately in the region of flexion between the foot and lower leg, i.e. in the region above the ankle. The resultant stabilization by means of tension advantageously increases the safety, in particular in the heel region.

In this connection, an embodiment of the invention, in which the at least one strap is additionally also configured to exert a tensile force on the metatarsus region of a foot located in the receiving region, said tensile force acting in the direction of the main plane of the inner shell, is particularly preferred. This can be brought about, for example, by the at least one strap extending in respect of its width from the region of the rear wall of the inner shell parallel to the longitudinal axis of the inner shell as far as at least the center of the receiving region. A strap designed in such a way, in addition to stabilizing the ankle, also advantageously makes it possible to stabilize the foot in the metatarsus region.

Alternatively thereto, in an embodiment of the invention, the foot support system can also comprise two straps, wherein a first strap is arranged in the region of the rear wall of the inner shell within the foot support system and is configured to exert a tensile force on the ankle of a foot located in the receiving region, said tensile force acting both in the direction of the main plane of the inner shell and in the direction of the rear wall; and wherein a second strap is arranged spaced apart from the first strap along the longitudinal axis of the foot support system in the direction of the side of the inner shell opposite the rear wall and is configured to exert a tensile force on the metatarsus region of a foot located in the receiving region, said tensile force acting in the direction of the main plane of the inner shell. Such an embodiment with two straps advantageously makes it possible to control the action of force in the region of the ankle and the action of force in the region of the metatarsus independently of each other.

In a further preferred embodiment, the strap or optionally the straps can be formed integrally, wherein one end of the strap or of the straps is irreversibly connected to a longitudinal side of the inner shell and/or of the outer shell, and the strap or the straps for fixing a foot can be tensioned beyond the receiving region of the inner shell onto the other longitudinal side where the other end of the strap or of the straps is reversibly connectable to the inner shell and/or outer shell. For this purpose, an eyelet or loop or a similar fastening means for the reversible fastening can be provided on the longitudinal side of the inner shell and/or of the outer shell opposite the fixed end of the strap or the straps, through which the strap or the straps can be guided and then in each case fastened reversibly to themselves, for example by a touch and close fastener. As an alternative thereto, the strap or the straps can also be formed from an elastic material, in particular rubber, and can have fastening holes in each case at the end not connected irreversibly to a longitudinal side of the inner shell and/or of the outer shell, i.e. the respectively free end. At least one pin for the reversible fastening can then preferably be provided on the longitudinal side of the inner shell and/or of the outer shell opposite the fixed end of the strap or the straps, with a strap of this type being able to be hooked via one of its fastening holes onto said pin. The fastening holes here are preferably distributed over the strap or the straps in such a manner that different strap lengths can be set by selecting a certain fastening hole. However, the fastening means for the reversible fastening can also be formed by a latching mechanism or click mechanism, with the loose end of the strap or the straps being able to be designed corresponding to the corresponding fastening means and latched or clicked into place for the fastening. A strap configured in such a way or straps configured in such a way can advantageously be fastened, tensioned and also released again single-handedly by a person, for example by a care assistant. In addition, a strap formed integrally or straps configured integrally also advantageously makes/make it easier to apply more force for tensioning the strap.

Alternatively or cumulatively thereto, in a further embodiment of the invention the strap or optionally the straps can also be formed in multiple parts, in particular in two parts, wherein in each case one end of the parts of the strap or of the straps is irreversibly connected to one respective longitudinal side of the inner shell and/or of the outer shell, the parts of the strap or of the straps for fixing a foot can be tensioned beyond the receiving region of the inner shell in the direction of the respective other longitudinal side and the respectively loose ends of the parts of the strap or of the straps are connectable reversibly to one another. In this variant, the threading of the respective strap into said eyelet or loop is advantageously dispensed with, and/or the access to the respective fastening means can advantageously be simplified.

Finally, an embodiment of the foot support system according to the invention has proven expedient, in which the foot support system, preferably the inner shell, comprises a means for the angular adjustment of the receiving region of the inner shell with respect to the main plane of the outer shell. The possibility of the angular adjustment of the receiving region of the inner shell with respect to the main plane of the outer shell with the aid of a corresponding means for the angular adjustment makes it possible, in particular in the case of a patient whose foot or feet is or are affected by spasticity or another type of abnormal foot position, to adapt the contact region of the receiving region of the inner shell to the foot anatomy such that as uniform an interaction as possible between the receiving region of the inner shell and the patient's foot is achieved. This advantageously makes it possible to unilaterally avoid loadings of the ligament apparatus in the ankle. The means for angular adjustment can be realized by a ball and socket joint, via which the inner shell can be moved in relation to the outer shell. Alternatively or cumulatively thereto, the means for angular adjustment can also be designed as a portion of the receiving region that is movable in relation to the main plane of the inner shell, in particular as a pivotable and lockable plate.

By virtue of its modular setup consisting of outer shell, inner shell formed corresponding thereto and strap, the foot support system according to the invention fits a simple and quick connection, which is comfortable for the patient, to a foot module to provide automated kinesitherapy. The foot support system advantageously protects and stabilizes the patient's foot particularly during movement.

### BRIEF DESCRIPTION OF THE SEVERAL VIEWS OF THE DRAWINGS

Additional details and further advantages of the invention are described below on the basis of preferred exemplary embodiments, to which the present invention is not limited, however, and in conjunction with the accompanying drawing, in which, schematically:

FIG. 1 shows a side view of an embodiment of a foot module of a rehabilitation mechanism together with an embodiment of a foot support system according to the invention for said foot module;

FIG. 2 shows a top view of an embodiment of a foot support system according to the invention;

FIG. 3 shows a side view of the embodiment of the invention from FIG. 2;

FIG. 4 shows a side view of an embodiment of an inner shell according to the invention;

FIG. 5a shows the inner shell from FIG. 4 in a top view of a receiving region, i.e. the top side of the inner shell;

FIG. 5b shows the inner shell from FIGS. 4 and 5a in atop view of the bottom side of the inner shell;

FIG. 6a shows an embodiment of an outer shell according to the invention in a top view of a side of the outer shell facing the inner shell, i.e., in this case, the top side of the outer shell;

FIG. 6b shows the outer shell from FIG. 6a in a top view of the bottom side of the outer shell;

FIG. 7a shows a side view of a further embodiment of a foot support system according to the invention with a means for angular adjustment;

FIG. 7b shows a front view of the foot support system from FIG. 7a;

FIG. 8a shows a further embodiment of an inner shell according to the invention in a top view of the receiving region, i.e. the top side of the inner shell;

FIG. 8b shows the inner shell from FIG. 8a in a top view of the bottom side of the inner shell;

FIG. 9 shows a perspective view of a further embodiment of an outer shell according to the invention; and

FIG. 10 shows a further embodiment of a foot support system according to the invention with an inner shell, as shown in FIGS. 8a and 8b, and an outer shell, as shown in FIG. 9.

### DETAILED DESCRIPTION OF THE INVENTION

In the description below of preferred embodiments of the present invention, the same reference signs denote identical or comparable components.

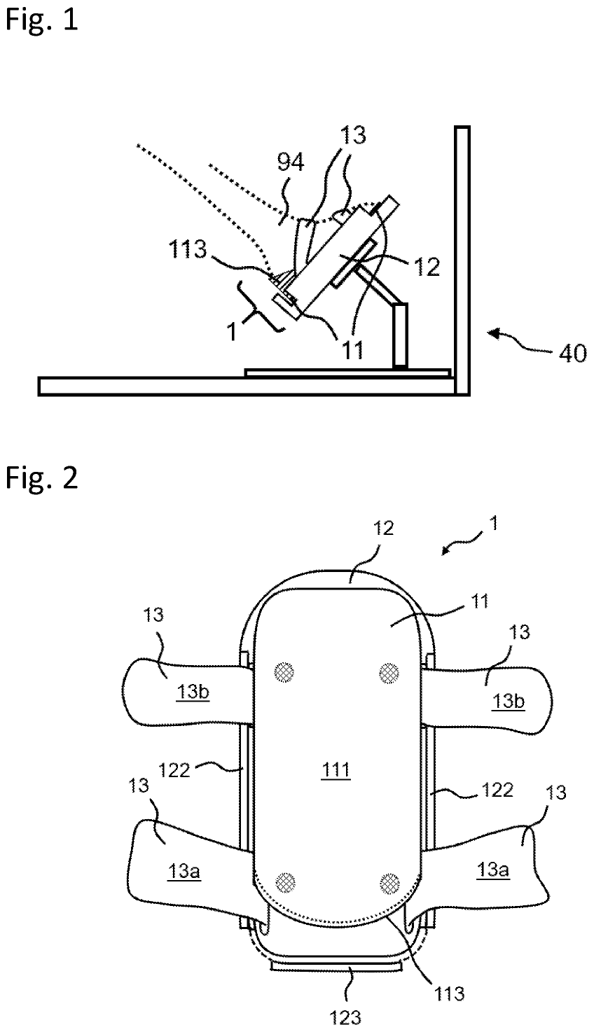

FIG. 1 shows a side view of an embodiment of a foot module 40 of a rehabilitation mechanism together with an embodiment of a foot support system 1 according to the invention for said foot module 40.

The foot support system 1 according to the invention for a foot module 40 of a rehabilitation mechanism comprises at least an inner shell 11 for receiving a person's foot 94, an outer shell 12 for connection to a foot module 40 of a rehabilitation mechanism; and at least one strap 13 for fixing the foot 94 to the foot support system 1. The outer shell 12 can preferably be formed from a metallic material and thus advantageously provides a stable, in particular torsion-proof and flexurally rigid, connection to the foot module 40 of the rehabilitation mechanism. The outer shell 12 can be permanently connected to the foot module 40 in particular via screw connections.

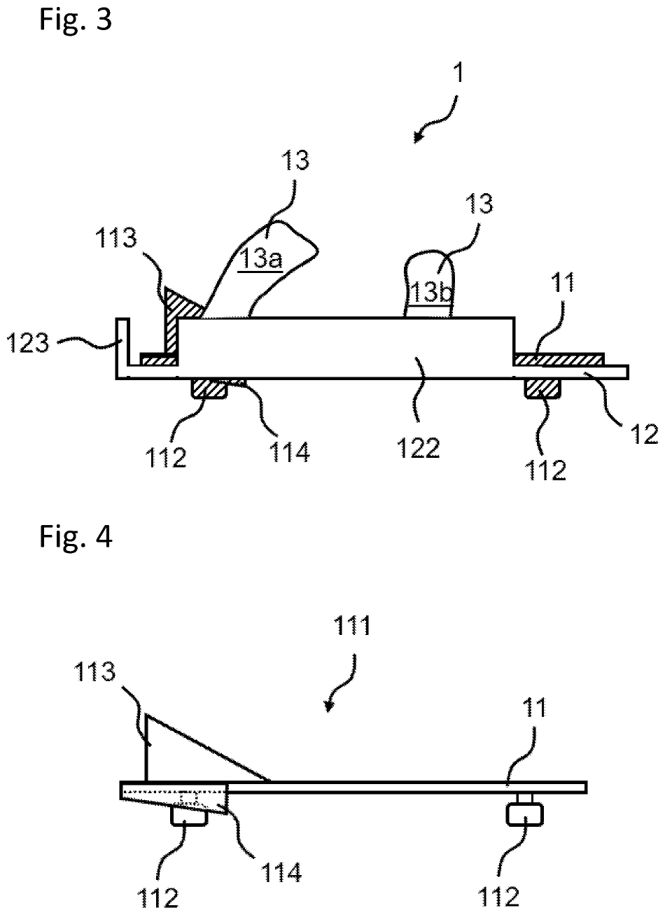

FIGS. 2 and 3 illustrate, in a top view (FIG. 2) and in a side view (FIG. 3), an embodiment of a foot support system 1 according to the invention.

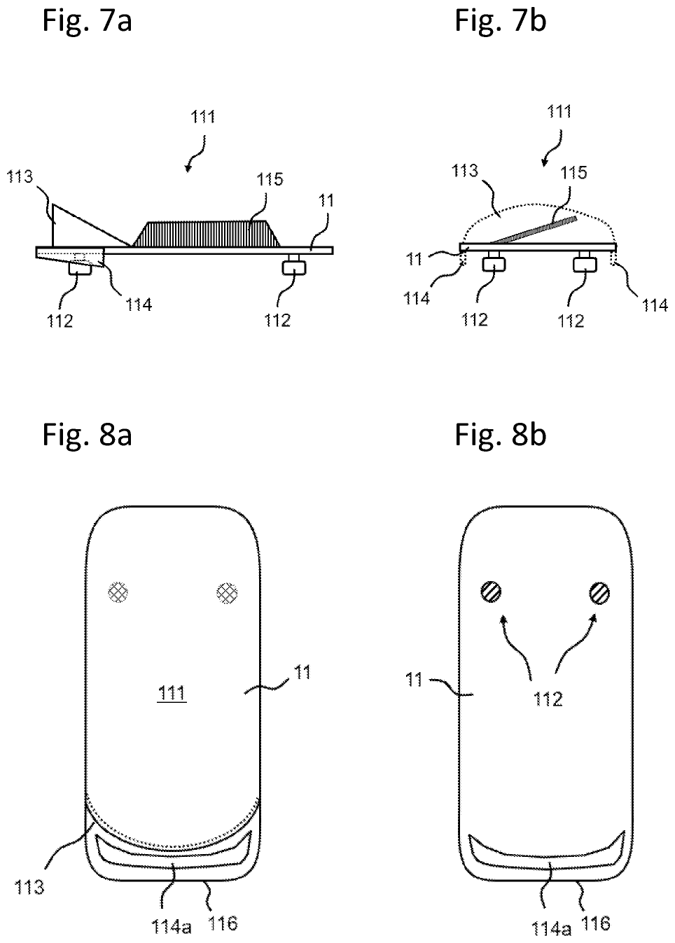

The inner shell 11 comprises a receiving region 111 and preferably a rear wall 113 which, preferably parabolically, can close the receiving region 111 of the inner shell 11 in the direction of a back wall 123 of the outer shell 12. To ensure optimum stabilization of the heel region of the foot 94, the rear wall 13 can preferably have a height, at least in sections, of between 8 and 10 cm, particularly preferably 9 cm (cf. also FIG. 7b in this regard). The inner shell 11 can be manufactured from plastic, preferably from hard plastic, which advantageously reduces the weight of the foot support system 1 and nevertheless can provide a certain degree of rigidity of the material and therefore better protective properties for the foot 94. Alternatively or cumulatively, the inner shell 11, in particular the receiving region 111 and/or the rear wall 113 of the inner shell 11, can also be provided with a padding layer, which advantageously increases the use comfort for the patient by damping the pressure loading on the foot 94, in particular also on the sole of the foot.

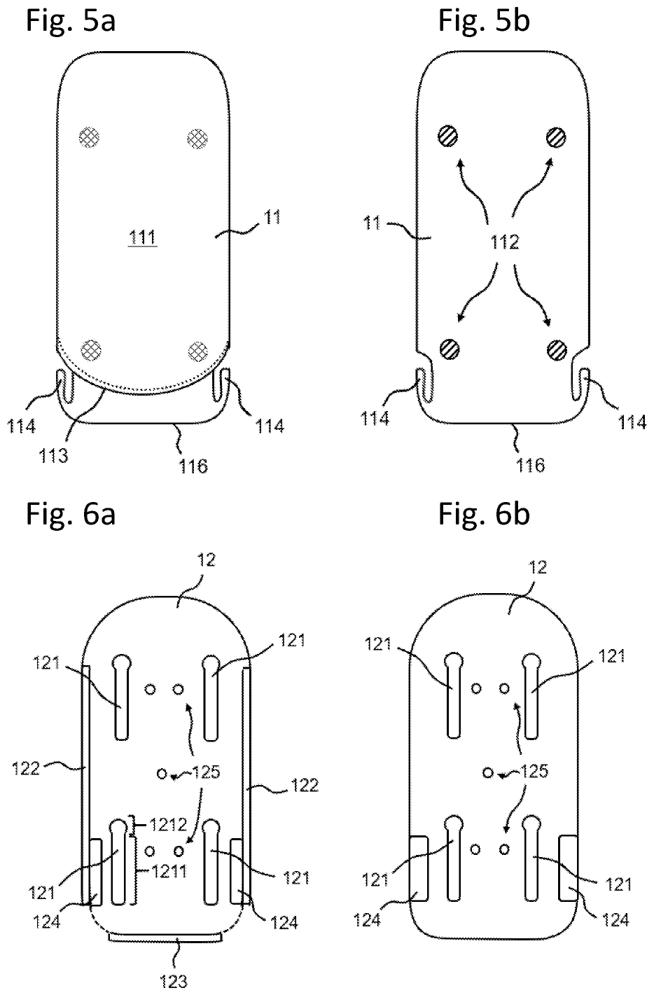

FIG. 4, FIG. 5a and FIG. 5b show a side view of an embodiment of an inner shell 11 according to the invention (FIG. 4), a top view of a receiving region 111, i.e. the top side of the inner shell 11 (FIG. 5a) and a top view of the bottom side of the inner shell 11 (FIG. 5b).

The inner shell 11 according to the invention comprises at least one connecting means 112 for reversibly connecting the inner shell 11 to the outer shell 12. As illustrated, the at least one connecting means 112 can preferably be arranged on a side of the inner shell 11 opposite a receiving region 111 for the foot 94 and/or (not illustrated here) in the region of at least one longitudinal and/or transverse side of the inner shell 11. The inner shell 11 can also comprise two, three or preferably, as shown in FIGS. 5a and 5b, four connecting means 112 which can be arranged on the inner shell 11, for example symmetrically with respect to the longitudinal axis thereof. The at least one connecting means 112 can preferably be designed as a mushroom-shaped component with a cap region, the diameter of which is designed corresponding to the diameter of an insertion opening 1212 of the receiving means 121 and a stalk region, the diameter of which is smaller than that of the cap region and can be designed corresponding to the width of a guide track 1211 of the receiving means 121.

FIG. 6a and FIG. 6b show a top view, corresponding to an embodiment of an outer shell 12 according to the invention, of a side of the outer shell 12 facing the inner shell 11, i.e., in this case, the top side of the outer shell 12 (FIG. 6a) and a top view of the bottom side of the outer shell 12 (FIG. 6b).

The outer shell 12 according to the invention comprises at least one receiving means 121 which is designed corresponding to the at least one connecting means 112 of the inner shell 11. As illustrated in FIGS. 6a and 6b, the receiving means 121 can preferably be arranged at least on a side of the outer shell 12 facing the inner shell 11 when the inner shell 11 and outer shell 12 are connected. In addition, the outer shell 12 can comprise side walls 122 and/or a back wall 123. Side walls 122 and/or a back wall 123 advantageously contribute to reinforcing the outer shell 12 and can create a subjectively better sensation overall for the patient when using the foot module 40. In particular in conjunction with the rear wall 113 of the inner shell 111, the back wall 123 can advantageously also support the foot 94, especially in the horizontal position. Corresponding to the inner shell 11, the outer shell 12 can also comprise two, three or preferably, as shown in FIGS. 6a and 6b, four connecting means 112 which can be arranged on the outer shell 12, for example, symmetrically with respect to the longitudinal axis thereof. The at least one receiving means 121 can preferably be formed in turn as a guide track 1211 with an insertion opening 1212 for the connecting means 112, the guide track 1211 being able to run in particular parallel to the longitudinal axis of the outer shell 12. In addition, the outer shell 12, as illustrated in FIGS. 6a and 6b, can comprise at least one fixing receptacle 124 which is designed corresponding to a fixing means 114 of the inner shell 11 (cf. FIGS. 5a and 5b) and which is configured to prevent a movement of the connecting means 112 within the receiving means 121, in particular along a guide track 1211 of the receiving means 121 toward the insertion opening 1212, when the fixing means 114 is operatively connected to the fixing receptacle 124. By way of example, FIGS. 5a and 5b show two fixing means 114 in the region of the rear wall 113 in each case on the right and left longitudinal sides of the inner shell 11. Said fixing means can interact in particular with the two fixing receptacles 124 in the region of the back wall 123 of the embodiment of the outer shell 12 that is illustrated in FIGS. 6a and 6b. Alternatively or cumulatively, at least one fixing means 114 can also be arranged in a central region of the inner shell 11 and/or in a region in the vicinity of the face side of the inner shell 11 (not illustrated here). A fixing means 114 placed in such a way can then preferably interact with a fixing receptacle 124 in the correspondingly central region and/or in the face region of the outer shell 12 (corresponds to the region on that side of the outer shell 12 which is opposite the back wall 123), in particular also with at least one fixing receptacle 124 arranged on one of the side walls 122.

FIG. 2 and FIG. 3 illustrate the described inner shell 11 and outer shell 12 in a state connected to a foot support system 1.

The at least one strap 13 according to the invention can be arranged in the region of the rear wall 113 of the inner shell 11 within the foot support system 1 and can be configured to exert a tensile force on the ankle of a foot 94 located in the receiving region 111, said tensile force acting both in the direction of the main plane of the inner shell 11 and in the direction of the rear wall 113. For this purpose, the strap 13, as can be seen in the side view in FIG. 3, can be arranged obliquely (corresponding, for example, to the arrangement under reference sign 13a in FIG. 3) on the inner shell 11 and/or outer shell 12, preferably on the rear wall 113 of the inner shell 11. Alternatively thereto, the strap 13 can also be arranged on the inner shell 11 and/or outer shell 12 via a rotatable connection and can thus be variably adjustable in particular in respect of its angle to the receiving region 111. In particular, if only one strap 13 is provided, an embodiment is preferred here in which said strap 13 is then also configured to exert a tensile force on the metatarsus region of a foot 94 located in the receiving region 111, said tensile force acting in the direction of the main plane of the inner shell 11. For this purpose, the strap 13 can preferably be selected to be of a width such that it reaches from the region of the rear wall 113 along the longitudinal side of the foot support system 1 as far as at least the center of the receiving region 111 and can thus span both the ankle region and the metatarsus region. The variable action of force on the foot 94, in the ankle region in the direction of the main plane of the inner shell 11 and in the direction of the rear wall 113 and in the metatarsus region in the direction of the main plane of the inner shell 11 can furthermore be reinforced by a suitable selection of material, namely by virtue of the elastic properties correspondingly differing by use of different materials and/or by different processing in the different strap regions.

Alternatively thereto and as shown by way of example in FIG. 2 and FIG. 3, the foot support system 1 can also comprise two straps 13, wherein a first strap 13a can be arranged in the region of the rear wall 113 of the inner shell 11 within the foot support system 1 and can be configured to exert a tensile force on the ankle of a foot 94 located in the receiving region 111, said tensile force acting both in the direction of the main plane of the inner shell 11 and in the direction of the rear wall 113; and wherein a second strap 13b is arranged spaced apart from the first strap 13a along the longitudinal axis of the foot support system 1 in the direction of the side of the inner shell 11 opposite the rear wall 113 and can be configured to exert a tensile force on the metatarsus region of a foot 94 located in the receiving region 111, said tensile force acting in the direction of the main plane of the inner shell 11.

In both variants, i.e. with a (wide) strap 13 or with two spaced-apart straps 13a and 13b, the strap or the straps 13 can each be formed integrally or in multiple parts.

If the at least one strap 13 is formed integrally, one end of the strap 13 can preferably be connected irreversibly to a longitudinal side of the inner shell 11 and/or of the outer shell 12, and the strap 13 for fixing a foot 94 can be tensioned beyond the receiving region 111 of the inner shell 11 onto the other longitudinal side where the other end of the strap 13 is reversibly connectable to the inner shell 11 and/or outer shell 12. If the at least one strap 13 is formed in multiple parts, in particular two parts, in each case one end of the parts of the strap 13 can preferably be connected irreversibly to one respective longitudinal side of the inner shell 11 and/or the outer shell 12, the parts of the strap 13 for fixing a foot 94 can be tensioned beyond the receiving region 111 of the inner shell 11 in the direction of the respective other longitudinal side and the respectively loose ends of the parts of the strap 13 can be connectable reversibly to one another. The reversible connection can be realized, for example, by a touch and close fastener, by a press stud fastener or by a belt buckle.

FIG. 7a and FIG. 7b show a side view (FIG. 7a) and a front view (FIG. 7b) of a further embodiment of a foot support system 1 according to the invention with a means 115 for angular adjustment. The foot support system 1, preferably the inner shell 11 as illustrated here, can preferably comprise a means 115 for the angular adjustment of the receiving region 111 of the inner shell 11 with respect to the main plane of the outer shell 12, with which the contact region of the receiving region 111 of the inner shell 11 can advantageously be adapted to the anatomy of the foot 94 in such a manner that as uniform an interaction as possible between the receiving region 111 of the inner shell 11 and the patient's foot 94 is achieved.

FIGS. 8a and 8b show a further embodiment of an inner shell 11 according to the invention in a top view of the receiving region 111 (FIG. 8a), i.e. the top side of the inner shell 11, and in a top view of the bottom side of the inner shell 11 (FIG. 8b).

In this embodiment, the inner shell 11 can comprise a fixing means 114a which is configured as an opening designed corresponding to a back wall 123 of the outer shell 12. The inner shell 11 here in turn can comprise a rear wall 113 which closes the receiving region 111 of the inner shell 11 in the direction of the back wall 123 of the outer shell 12. The fixing means 114a, which is configured as an opening, can then preferably be arranged in the region between said rear wall 113 and a rear end 116 of the inner shell 11. In this embodiment, the at least one connecting means 112 for reversibly connecting the inner shell 11 to the outer shell 12 can be configured as a magnet and can interact with a receiving means 121, configured as a magnetic region, of the outer shell 12 when the inner shell 11 is connected to the outer shell 12 (not shown here). However, as illustrated here, the at least one connecting means 112 can also in turn be configured as a mushroom-shaped component with a cap region, the diameter of which is designed corresponding to the diameter of an insertion opening 1212 of the receiving means 121, and a stalk region, the diameter of which is designed to be smaller than that of the cap region and corresponding to the width of a guide track 1211 of the receiving region 121.

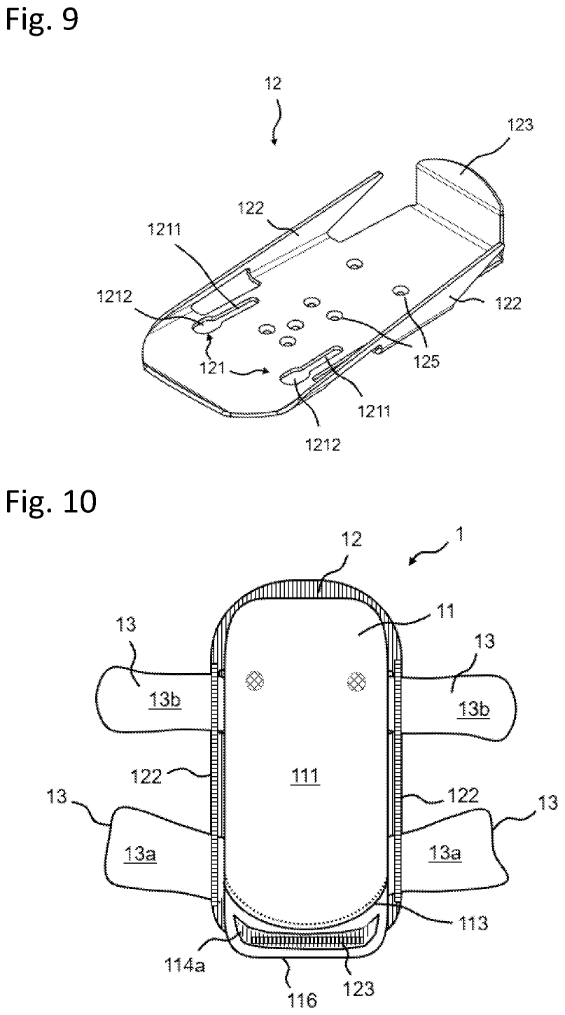

In addition, a perspective view of a further embodiment of an outer shell 12 according to the invention is illustrated in FIG. 9.

As can be seen, this embodiment of the outer shell 12, similarly to the outer shell 12 already shown in FIG. 6a and FIG. 6b, can comprise one or more fastening holes 125 for fastening the outer shell 12 to the foot module 40, and can also have side surfaces 122 and a back wall 123. According to the invention, the outer shell 12 comprises at least one receiving means 121 which is formed corresponding to the at least one connecting means 112 of the inner shell 11. In the embodiment illustrated here, in particular two receiving means 121 are provided which are arranged in the front region of the outer shell 12 opposite the back wall 123. In this example, the receiving means 121 are designed as guide tracks 1211 each having an insertion opening 1212 for a connecting means 112, wherein the respective guide track 1211 runs in particular parallel to the longitudinal axis of the outer shell 12. Moreover, in this embodiment of the outer shell 12, the rear end of the side walls 122 that in each case faces the back wall 123 can be wedge-shaped and can in each case form a nose running obliquely with respect to the area of the outer shell 12. The angle that said wedge-shaped nose forms with respect to the area, in particular on its side facing the area of the outer shell 12, can preferably be selected here in such a manner that a strap 13 or 13a for fixing the foot 94 to the foot support system 1, which, in this embodiment of an outer shell 12 according to the invention, advantageously only has to be hung, for fastening purposes, into the rear, wedge-shaped end of one of the side walls 122 that faces the back wall 123, runs obliquely over a foot 94 arranged in the foot support system 1 and can thereby advantageously exert a force on said foot 94, said force acting both in the direction of the main plane of the inner shell 11 and in the direction of the rear wall 113. FIG. 10 finally shows a further embodiment of a foot support system 1 according to the invention with an inner shell, as shown in FIGS. 8a and 8b, and an outer shell, as shown in FIG. 9.

In order to connect an inner shell 11 in the embodiment of FIGS. 8a and 8b to an outer shell 12 according to FIG. 9 to form a foot support system 1, the inner shell 1 can advantageously be inserted with its two mushroom-shaped connecting means 112 into the two receiving means 121 via the two insertion openings 1212 and can then be pushed in the direction of the back wall 123 of the outer shell 12 until the back wall 123 can be plugged through the fixing means 114a, which is configured as an opening, of the inner shell 11. The connecting means 112 likewise run here within the two guide tracks 1211 in the direction of the back wall 123 into the region of the respective guide track 1211 of narrower width. Release of the inner shell 11 from the base plate of the outer shell 12 is prevented in this state by the cap region of the mushroom-shaped connecting means 112. Slipping of the inner shell 11 forward parallel to the area of the outer shell 12, i.e. away from the back wall 123, is advantageously prevented by the interaction between back wall 123 and the web region of the fixing means 114a, configured as an opening, at the rear end 116 of the inner shell 11.

Alternatively or cumulatively thereto, slipping of the inner shell 11 parallel to the area of the outer shell 12 forward can also be prevented by a locking mechanism, in particular a screw fixing, the locking mechanism (not shown here) being able to reversibly connect the rear wall 113 of the inner shell 11 to the back wall 123 of the outer shell 12. Such a locking mechanism can also reversibly connect an inner shell 11, as shown in FIGS. 5a and 5b, to an outer shell 12 according to one of the embodiments from FIGS. 6a and 6b or FIG. 9 and can thereby advantageously secure it against unintentionally slipping out forward.

The present invention relates to a foot support system 1 for a foot module 40 of a rehabilitation mechanism, at least comprising an inner shell 11 for receiving a person's foot 94, an outer shell 12 for connection to a foot module 40 of a rehabilitation mechanism; and at least one strap 13 for fixing the foot 94 to the foot support system 1; wherein the inner shell 11, on its side opposite a receiving region 111 for the foot 94, comprises at least one connecting means 112 for reversibly connecting the inner shell 11 to the outer shell 12; and wherein the outer shell 12, at least on its side facing the inner shell 11 when the inner shell 11 and outer shell 12 are connected, comprises at least one receiving means 121 which is designed corresponding to the at least one connecting means 112 of the inner shell 11. By virtue of its modular set up, it permits simple, quick and comfortable connection to a foot module 40 and advantageously protects and stabilizes the foot 94 particularly during movement.

### LIST OF REFERENCE SIGNS

1 Foot support system
11 Inner shell
111 Receiving region
112 Connecting means
113 Rear wall of the inner shell
114 Fixing means
114a Fixing means (configured as an opening)
115 Means for angular adjustment of the receiving region (111) of the inner shell (11) with respect to the main plane of the outer shell (12)
116 Rear end of the inner shell (11)
12 Outer shell
121 Receiving means for the connecting means (112) of the inner shell (11)
1211 Guide track
1212 Insertion opening
122 Side wall
123 Back wall
124 Fixing receptacle for the fixing means (114) of the inner shell (11) 125 Fastening hole for fastening the outer shell (12) to the foot module (40)
13 Strap
13a First strap
13b Second strap
40 Foot module
94 Foot

1. A foot support system for a foot module of a rehabilitation mechanism, the foot support system comprising:
an inner shell for receiving a person's foot;
an outer shell for connection to a foot module of a rehabilitation mechanism; and
at least one strap for fixing the foot to the foot support system;
wherein the inner shell comprises at least one connecting means for reversibly connecting the inner shell to the outer shell; and
wherein the outer shell comprises at least one receiving means which is designed corresponding to the at least one connecting means of the inner shell.

2. The foot support system of claim 1, wherein:
the at least one connecting means for reversibly connecting the inner shell to the outer shell is arranged on a side of the inner shell opposite a receiving region for the foot and/or in the region of at least one longitudinal side and/or transverse side of the inner shell; and
the at least one receiving means, which is designed corresponding to the connecting means, is arranged at least on a side of the outer shell facing the inner shell when the inner shell and outer shell are connected.

3. The foot support system of claim 1, wherein the at least one connecting means is configured as a magnet, and the at least one receiving means is configured as a magnetic region of a side of the outer shell facing the inner shell when the inner shell and outer shell are connected.

4. The foot support system of claim 1, wherein:
the receiving means is designed as a guide track with an insertion opening for the connecting means, the guide track running in particular parallel to the longitudinal axis of the outer shell; and/or
the receiving means is designed as a latching mechanism, in particular as a spring latching mechanism, into which the connecting means is latched.

5. The foot support system of claim 4, wherein the at least one connecting means is designed as a mushroom-shaped component with a cap region, the diameter of which is designed corresponding to the diameter of the insertion opening of the receiving means, and a stalk region, the diameter of which is smaller than that of the cap region and is designed corresponding to the width of the guide track of the receiving means.

6. The foot support system of claim 1, wherein the inner shell comprises two, three or four connecting means, and the outer shell correspondingly comprises two, three or four receiving means.

7. The foot support system of claim 1, wherein the outer shell comprises at least one fixing receptacle which is designed corresponding to a fixing means of the inner shell and which is configured to prevent a movement of the connecting means within the receiving means when the fixing means is operatively connected to the fixing receptacle.

8. The foot support system of claim 1, wherein the inner shell comprises a rear wall which, closes the receiving region of the inner shell in the direction of a back wall of the outer shell.

9. The foot support system of claim 1, wherein the inner shell comprises a fixing means which is configured as an opening designed corresponding to a back wall of the outer shell, the inner shell comprising a rear wall which closes the receiving region of the inner shell in the direction of the back wall of the outer shell, and wherein the fixing means is configured as an opening arranged in the region between said rear wall and a rear end of the inner shell.

10. The foot support system of claim 8, wherein the at least one strap is arranged in the region of the rear wall of the inner shell within the foot support system and is configured to exert a tensile force on the ankle of a foot located in the receiving region, said tensile force acting both in the direction of the main plane of the inner shell and in the direction of the rear wall.

11. The foot support system of claim 10, wherein the at least one strap is configured to exert a tensile force on the metatarsus region of a foot located in the receiving region, said tensile force acting in the direction of the main plane of the inner shell.

12. The foot support system of claim 8, comprising two straps,
wherein a first strap is arranged in the region of the rear wall of the inner shell within the foot support system and is configured to exert a tensile force on the ankle of a foot located in the receiving region, said tensile force acting both in the direction of the main plane of the inner shell and in the direction of the rear wall; and
wherein a second strap is arranged spaced apart from the first strap along the longitudinal axis of the foot support system in the direction of the side of the inner shell opposite the rear wall and is configured to exert a tensile force on the metatarsus region of a foot located in the receiving region, said tensile force acting in the direction of the main plane of the inner shell.

13. The foot support system of claim 1, wherein the strap or the straps is or are formed integrally, wherein one end of the strap or of the straps is irreversibly connected to a longitudinal side of the inner shell and/or of the outer shell, and the strap or the straps for fixing a foot can be tensioned beyond the receiving region of the inner shell onto the other longitudinal side where the other end of the strap or of the straps is reversibly connectable to the inner shell and/or outer shell.

14. The foot support system of claim 1, wherein the strap or the straps is or are formed in multiple parts, in particular in two parts, wherein in each case one end of the parts of the strap or of the straps is irreversibly connected to one respective longitudinal side of the inner shell and/or of the outer shell, the parts of the strap or of the straps for fixing a foot can be tensioned beyond the receiving region of the inner shell in the direction of the respective other longitudinal side and the respectively loose ends of the parts of the strap are connectable reversibly to one another.

15. The foot support system of claim 1, wherein the foot support system comprises a means for the angular adjustment of the receiving region of the inner shell with respect to the main plane of the outer shell.

16. The foot support system of claim 8, wherein the rear wall has, at least in sections, a height of 8 to 10 cm.

17. The foot support system of claim 16, wherein the rear wall has, at least in sections, a height of 9 cm.
